(19) United States
(12) Patent Application Publication
(10) Pub. No.: US 2025/0376987 A1
(43) Pub. Date: Dec. 11, 2025

(54) IN-SITU ELECTROPLATED SHEATH FOR COMPOSITE FAN BLADE

(71) Applicant: RTX Corporation, Farmington, CT (US)

(72) Inventor: Thomas Robertson, Glastonbury, CT (US)

(73) Assignee: RTX Corporation, Farmington, CT (US)

(21) Appl. No.: 18/738,254

(22) Filed: Jun. 10, 2024

(51) Int. Cl. F04D 29/32; F04D 29/02; F04D 29/38

(52) U.S. Cl. CPC F04D 29/324; F04D 29/023; F04D 29/388; F05D 2240/30; F05D 2300/603

(57) ABSTRACT

An electroplated sheath for a composite fan blade including a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; and a sheath electroplated to a surface of the composite fan blade proximate at least one of the leading edge, the trailing edge and the tip.

### BACKGROUND

The present disclosure is directed to the improved electroplated sheath for composite fan blade.

Thermoplastic or Thermoset composite fan blades fabricated using prepreg fabric or tape require novel methods of improving through-thickness impact capability. During impact, tip deflections can cause delamination of plies, leading to excess damage and limitations to fly-back thrust capability.

Current composite fan blade tip protection uses an adhesively bonded titanium sheath and adhesively bonded titanium tip caps. The complex machining required to create titanium details is cost prohibitive, and the design is completely reliant on adhesive bond to maintain structural integrity and prevention of delamination.

Initial impact testing of conventional designs has indicated difficulty in maintaining adhesive bond in highly dynamic impact events, leading to liberation of metal details which can create additional damage risk to adjacent hardware.

Composite fan blades do not have similar corrosion risks, so alternative attachment schemes besides adhesives can be considered for improved performance and manufacturability.

### SUMMARY

In accordance with the present disclosure, there is provided an electroplated sheath for a composite fan blade comprising a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; and a sheath electroplated to a surface of the composite fan blade proximate at least one of the leading edge, the trailing edge and the tip.

A further embodiment of any of the foregoing embodiments may additionally and/or alternatively include the electroplated sheath for a composite fan blade further comprising a bond coat disposed onto the surface prior to the application of the sheath.

A further embodiment of any of the foregoing embodiments may additionally and/or alternatively include the sheath comprises a sheath material capable of being electroplated onto the fan blade.

A further embodiment of any of the foregoing embodiments may additionally and/or alternatively include the sheath extends from a location proximate the platform portion to the tip.

A further embodiment of any of the foregoing embodiments may additionally and/or alternatively include the sheath extends from the tip toward the root portion a predetermined length along the airfoil portion proximate the trailing edge.

A further embodiment of any of the foregoing embodiments may additionally and/or alternatively include the sheath extends across the airfoil portion chord-wise a predetermined distance.

A further embodiment of any of the foregoing embodiments may additionally and/or alternatively include the sheath material comprises a nickel alloy plating material.

In accordance with the present disclosure, there is provided an electroplated sheath for a composite fan blade comprising a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; and a sheath electroplated to a surface of the composite fan blade proximate the leading edge, the trailing edge and the tip.

A further embodiment of any of the foregoing embodiments may additionally and/or alternatively include the electroplated sheath for a composite fan blade further comprising a bond coat disposed onto the surface of the composite fan blade proximate the leading edge, the trailing edge and the tip prior to the application of the sheath.

A further embodiment of any of the foregoing embodiments may additionally and/or alternatively include the sheath comprises a sheath material configured for electroplating onto the fan blade.

A further embodiment of any of the foregoing embodiments may additionally and/or alternatively include the sheath extends across the airfoil portion chord-wise a predetermined distance.

A further embodiment of any of the foregoing embodiments may additionally and/or alternatively include the sheath extends from a location proximate the platform portion to the tip.

A further embodiment of any of the foregoing embodiments may additionally and/or alternatively include the sheath extends from the tip toward the root portion a predetermined length along the airfoil portion proximate the trailing edge.

In accordance with the present disclosure, there is provided a process for electroplating a sheath for a composite fan blade comprising fabricating a composite fan blade comprising a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; masking a portion of the airfoil portion; and electroplating a sheath material onto a surface of the composite fan blade proximate at least one of the leading edge, the trailing edge and the tip.

A further embodiment of any of the foregoing embodiments may additionally and/or alternatively include the process further comprising metalizing the surface with a bond coat of the composite fan blade proximate the leading edge, the trailing edge and the tip prior to electroplating the surface.

A further embodiment of any of the foregoing embodiments may additionally and/or alternatively include the process further comprising removal of excess sheath material.

A further embodiment of any of the foregoing embodiments may additionally and/or alternatively include the process further comprising extending the sheath along the surface proximate the leading edge from a location proximate the platform portion to the tip.

A further embodiment of any of the foregoing embodiments may additionally and/or alternatively include the process further comprising shaping the leading edge and tip.

A further embodiment of any of the foregoing embodiments may additionally and/or alternatively include the process further comprising extending the sheath from the tip toward the root portion a predetermined length along the airfoil portion proximate the trailing edge.

A further embodiment of any of the foregoing embodiments may additionally and/or alternatively include the process further comprising extending the sheath across the airfoil portion chord-wise a predetermined distance.

Other details of the electroplated sheath for composite fan blade are set forth in the following detailed description and the accompanying drawings wherein like reference numerals depict like elements.

### BRIEF DESCRIPTION OF THE DRAWINGS

FIG. 1 is a cross section view of an exemplary gas turbine engine.

FIG. 2 is a schematic view of a fan blade for use in the gas turbine engine shown in FIG. 1.

FIG. 3 is a perspective view of a rotor disk with the fan blade of FIG. 2 installed.

FIG. 4 is a schematic representation of a nickel-plated sheath and cap for composite fan blade.

FIG. 5 is a process map.

### DETAILED DESCRIPTION

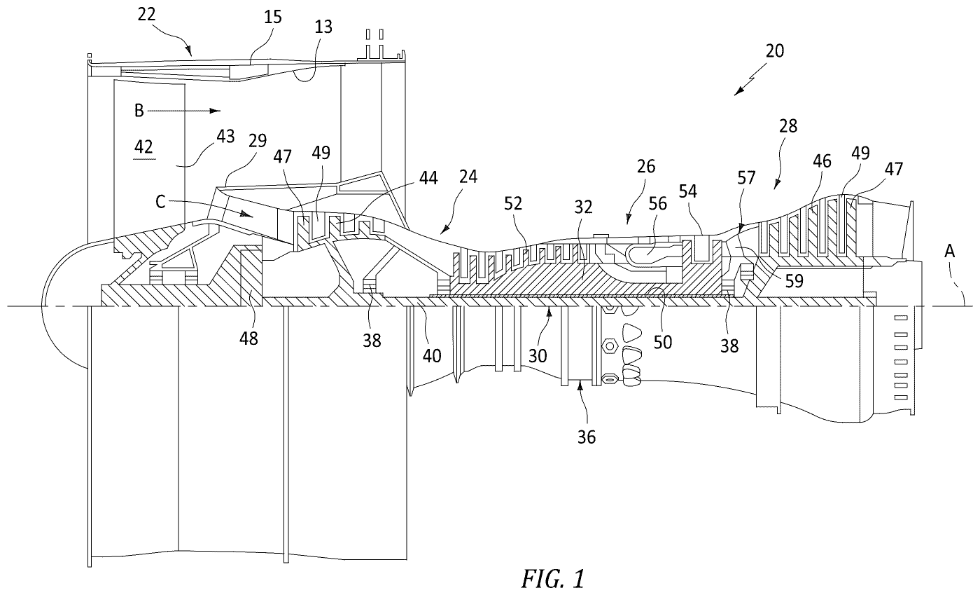

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of static vanes adjacent the rotatable airfoils. The rotatable airfoils and vanes are schematically indicated at 47 and 49.

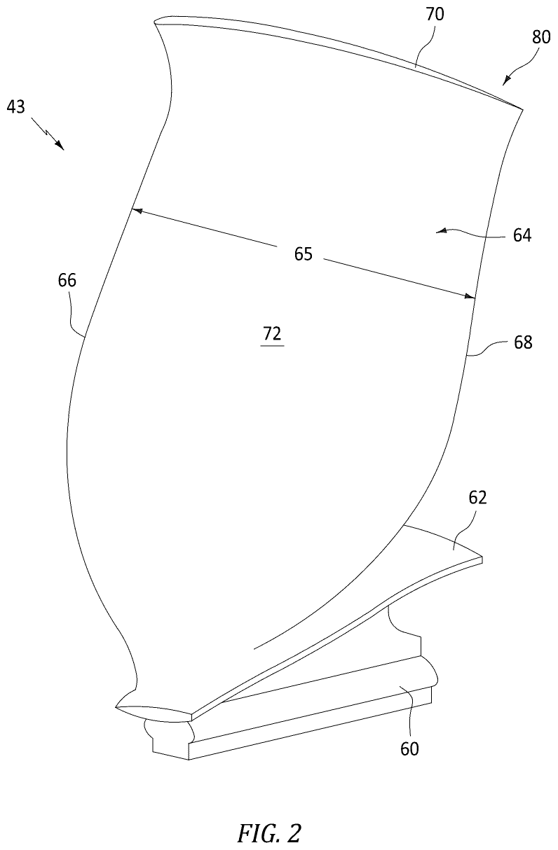

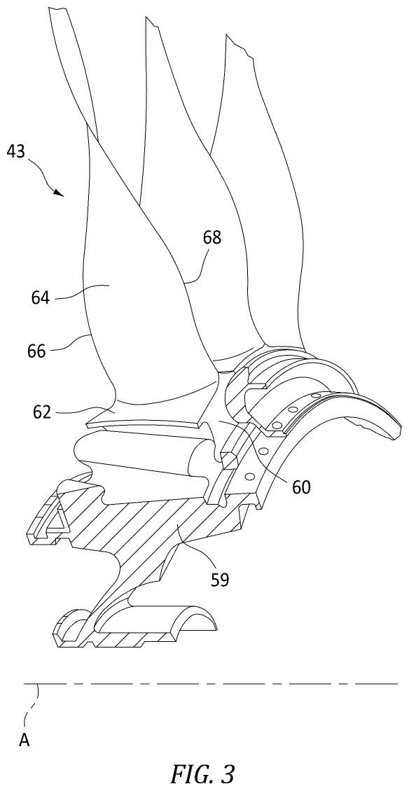

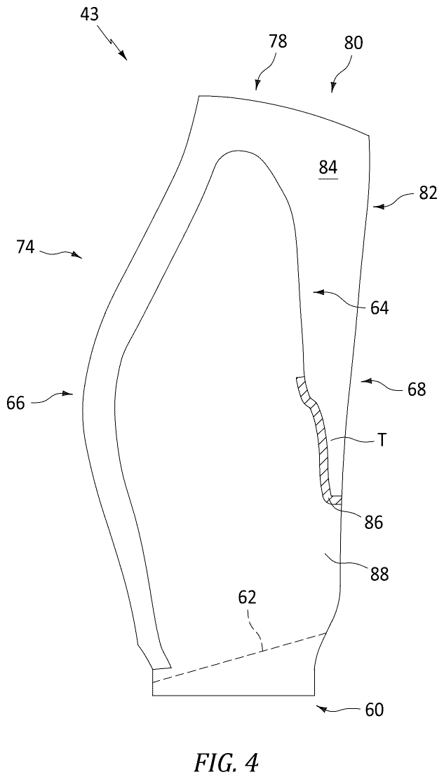

Referring also to FIG. 2, FIG. 3 and FIG. 4, the fan section 22 includes a plurality of circumferentially spaced fan blades 43 which may be made of a high-strength, low weight material such as an aluminum alloy, titanium alloy, composite material or combinations thereof. It should be understood that although a single fan stage typical of a high bypass gas turbofan engine architecture is illustrated and described in the disclosed embodiments, other stages which have other blades inclusive but not limited to fan blades, high pressure compressor blades and low pressure compressor blades may also benefit from the disclosed process.

Each fan blade 43 generally includes an innermost root portion 60, an intermediate platform portion 62 (may or may not be integral to fan blade 43), and an outermost airfoil portion 64. In one form, the root portion 60 defines an attachment such as an inverted fir tree, bulb, or dovetail, so the fan blade 43 is slidably received in a complimentary configured recess provided in a fan rotor 59 (FIG. 3). The platform portion 62 generally separates the root portion 60 and the airfoil portion 64 to define an inner boundary of the air flow path. The airfoil portion 64 defines a blade chord 65 between a leading edge 66, which may include various forward and/or aft sweep configurations, and a trailing edge 68. A concave pressure side 70 and a convex suction side 72 are defined between the leading edge 66 and the trailing edge 68. Although the fan blade 43 is illustrated in the disclosed non-limiting embodiment, compressor blades, turbofan blades, turboprop propeller blades, tilt rotor props, vanes, struts, and other airfoils may benefit from the disclosed electroplated sheath.

Referring also to FIG. 4, the fan blade 43 can be constructed from composite material 74. The composite material 74 can include polymer matrix composite material for fan blades 43. The polymer matrix composites are materials made up of fibers that are embedded in an organic polymer matrix. These fibers are introduced to enhance selected properties of the material. Polymers are reinforced with fibers which can be continuous single or chopped multi-filaments that are woven into cloth and other types of preformed textiles, or unidirectional tape. These fibers can be impregnated into the matrix polymer in liquid form by injection, extrusion, pressing or stamping and then cured to produce the final composite. A leading edge sheath 76 can be electroplated to the fan blade 43 proximate the leading edge 66 of the fan blade 43. The leading edge sheath 76 can include metal material capable of being electroplated onto the fan blade 43. The leading edge sheath 76 encapsulates the fan blade 43 polymer matrix composite material 74. A tip cap 78 is also shown electroplated to the fan blade 43 proximate a tip 80 of the fan blade 43. The tip cap 78 can be made of metal material capable of being electroplated onto the fan blade 43.

A trailing edge sheath 82 is also shown electroplated to the fan blade 43 proximate the trailing edge 68. The trailing edge sheath 82 can extend from the tip 80 toward the root portion 60 a predetermined length along the airfoil portion 64.

The leading edge sheath 76, tip cap 78 and trailing edge sheath 82 can be electroplated onto the fan blade 43 and extend across the fan blade 43 chord-wise a predetermined distance. In an exemplary embodiment, the leading edge sheath 76 can extend proximate the leading edge for the full span of the leading edge 66. The leading edge sheath 76 can extend from the leading edge 66 across the chord from about 5 percent to about 20 percent of the chord. In an exemplary embodiment, the tip cap 78 can extend from the tip 80 along the span from about 1 percent to about 30 percent. The tip cap 78 can extend along the chord from about 30 percent to about 100 percent. In an exemplary embodiment, the trailing edge sheath 82 can extend from about 30 percent to about 80 percent of the span and from about 5 percent to about 20 percent of the chord dimension.

A percentage of the airfoil portion 64 can remain uncoated, without the sheath material 84. The uncoated section can be masked prior to electroplating to prevent the electroplating sheath material 84 from adhering to the surface 88.

The leading edge sheath 76, tip cap 78 and trailing edge sheath 82 can be electroplated with the sheath material 84 onto the fan blade 43 simultaneously and form a contiguous sheath 84. In an exemplary embodiment the sheath material 84 can include a nickel alloy plating material. The sheath material 84 can have a thickness T ranging from about 5 mils to about 30 mils. In an exemplary embodiment, the sheath material 84 can be electroplated to a thickness tailored to meet predetermined impact requirements while minimizing weight increase. In order to protect from erosion, the leading edge sheath 76 can include a greater thickness for erosion reparability in service.

In an exemplary embodiment, a prelayer/bond coat 86 can be disposed onto fan blade 43 surface 88 prior to the application of the sheath material 84. A spray process can be employed in the application of the prelayer/bond coat 86. The prelayer/bond coat 86 can be a material that enables the electroplating to be more effective. In an exemplary embodiment, a thin copper alloy layer can be applied as the prelayer/bond coat 86 to metalize the surface 88 in the locations of the subsequent sheath 84.

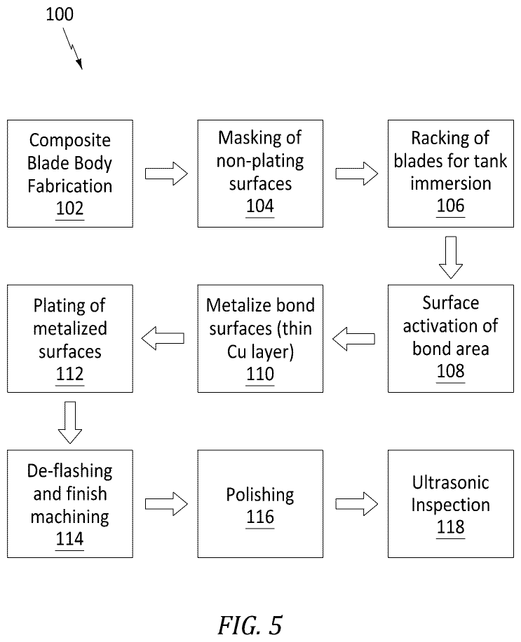

Referring also to FIG. 5, the process for creating the electroplated sheath for composite fan blade 100 includes a variety of steps. At step 102 the composite fan blade 43 can be fabricated from composite material 74. The composite blade body can be fabricated through fabric placement, pre-pregnation, resin transfer molding, compression molding and the like. At step 104 the surface 88 can be masked at locations that will not receive electroplating. The masking functions to protect the portions of the surface 88 from the required contact with the electroplating materials and prevents electroplating from occurring on portions of the surface 88. In exemplary embodiments, the surface 88 can be taped or a re-usable maskant can be employed. At step 106 a number of composite fan blades 43 can be racked in preparation for immersion in a tank for electroplating. At step 108 the surface 88 that is to be electroplated is activated for a bond coat 86 to be applied. An atomic layer of palladium or other means, such as plasma etching and the like can be utilized. At step 110 the surface 88 can be metalized with the prelayer/bond coat 86, such as a thin copper layer (<1 mil). The prelayer/bond coat 86 can create a mechanical interlocking with composite material to form an electroplate-able surface. At step 112 the electroplating of sheath material 84 can be applied onto the metalized bond coat 86. As an example, a nickel plating material can be applied to a predetermined thickness. At step 114 the excess sheath material 84 can be removed via de-flashing and finish machining techniques. Removal of nodules at tight radii and other regions of electrical concentration can be performed. The leading edge 66 and tip 80 can be shaped as needed. At step 116 the composite fan blade 43 with sheath material 84 can be polished to a desired surface finish. At step 118 the composite fan blade 43 with sheath material 84 can be inspected for defects, such as an ultrasonic inspection. The blade 43 can continue through the assembly processing.

A technical advantage of the disclosed electroplated sheath for composite fan blade includes a significant reduction in material and processing cost.

Another technical advantage of the disclosed electroplated sheath for composite fan blade includes obtaining equivalent erosion and stiffness capabilities.

Another technical advantage of the disclosed electroplated sheath for composite fan blade includes improved through-thickness impact capacity.

Another technical advantage of the disclosed electroplated sheath for composite fan blade includes no geometry mismatch or residual stress from bonding.

Another technical advantage of the disclosed electroplated sheath for composite fan blade includes no stiffness discontinuities, gaps, aero steps, or length mismatch between multiple titanium pieces.

Another technical advantage of the disclosed electroplated sheath for composite fan blade includes tailorable thickness and shape via plating process controls.

Another technical advantage of the disclosed electroplated sheath for composite fan blade includes uniform blade tip coverage with minimal manufacturing impact.

Another technical advantage of the disclosed electroplated sheath for composite fan blade includes mechanical locking of sheath and tip cap provides secondary retention over bonding alone.

Another technical advantage of the disclosed electroplated sheath for composite fan blade includes limited to no boutique processing or materials, standard electroplating after initial process development and setup.

Another technical advantage of the disclosed electroplated sheath for composite fan blade includes perfect electrical grounding between metallic and composite details to prevent static charge accumulation.

There has been provided an electroplated sheath for composite fan blade. While the electroplated sheath for composite fan blade has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. A composite fan blade comprising:
a root portion adjacent a platform portion and an airfoil portion adjacent the platform portion and a tip adjacent the airfoil portion opposite the root portion;
the airfoil portion defines a blade chord between a leading edge and a trailing edge; the airfoil portion defines a concave pressure side and a convex suction side defined between the leading edge and the trailing edge; and
a sheath electroplated to a surface of the composite fan blade proximate at least one of the leading edge, the trailing edge and the tip, wherein the sheath includes a leading edge sheath near the leading edge of the blade, a tip cap sheath near the tip and a trailing edge sheath near the trailing edge, wherein the leading edge sheath extends from the leading edge across the blade chord from 5 percent to 20 percent of the blade chord, the tip cap extends from the tip along a blade span from 1 percent to 30 percent and the tip cap extends along the blade chord from 30 percent to about 100 percent.

2. The composite fan blade according to claim 1, further comprising:
a bond coat disposed onto the surface prior to the application of the sheath.

3. The composite fan blade according to claim 1, wherein the sheath comprises a sheath material capable of being electroplated onto the fan blade.

4. The composite fan blade according to claim 1, wherein the sheath extends from a location proximate the platform portion to the tip.

5. The composite fan blade according to claim 1, wherein the sheath extends from the tip toward the root portion a predetermined length along the airfoil portion proximate the trailing edge.

6. The composite fan blade according to claim 1, wherein the sheath extends across the airfoil portion chord-wise a predetermined distance.

7. The composite fan blade according to claim 1, wherein the sheath comprises a nickel alloy plating material.

8. A composite fan blade comprising:
a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; and
a sheath electroplated to a surface of the composite fan blade proximate the leading edge, the trailing edge and the tip, wherein the sheath includes a leading edge sheath near the leading edge of the blade, a tip cap sheath near the tip and a trailing edge sheath near the trailing edge, wherein the leading edge sheath extends from the leading edge across the blade chord from 5 percent to 20 percent of the blade chord, the tip cap extends from the tip along a blade span from 1 percent to 30 percent and the tip cap extends along the blade chord from 30 percent to about 100 percent.

9. The composite fan blade according to claim 8, further comprising:
a bond coat disposed onto the surface of the composite fan blade proximate the leading edge, the trailing edge and the tip prior to the application of the sheath.

10. The composite fan blade according to claim 8, wherein the sheath comprises a sheath material configured for electroplating onto the fan blade.

11. The composite fan blade according to claim 8, wherein the sheath extends from a location proximate the platform portion to the tip.

12. The composite fan blade according to claim 8, wherein the sheath extends from the tip toward the root portion a predetermined length along the airfoil portion proximate the trailing edge.

13. The composite fan blade according to claim 8, wherein the sheath extends across the airfoil portion chord-wise a predetermined distance.

14. A process for electroplating a sheath for a composite fan blade comprising:
fabricating a composite fan blade comprising a root portion adjacent a platform portion and an airfoil portion adjacent the platform portion and a tip adjacent the airfoil portion opposite the root portion; the airfoil portion defines a blade chord between a leading edge and a trailing edge; the airfoil portion defines a concave pressure side and a convex suction side defined between the leading edge and the trailing edge; and
masking a portion of the airfoil portion; and
electroplating a sheath material onto a surface of the composite fan blade proximate at least one of the leading edge, the trailing edge and the tip, wherein the sheath includes a leading edge sheath near the leading edge of the blade, a tip cap sheath near the tip and a trailing edge sheath near the trailing edge, wherein the leading edge sheath extends from the leading edge across the blade chord from 5 percent to 20 percent of the blade chord, the tip cap extends from the tip along a blade span from 1 percent to 30 percent and the tip cap extends along the blade chord from 30 percent to about 100 percent.

15. The process of claim 14, further comprising:
metalizing the surface with a bond coat of the composite fan blade proximate the leading edge, the trailing edge and the tip prior to electroplating the surface.

16. The process of claim 14, further comprising:
removal of excess sheath material.

17. The process of claim 14, further comprising:
extending the sheath material along the surface proximate the leading edge from a location proximate the platform portion to the tip.

18. The process of claim 14, further comprising:
shaping the leading edge and tip.

19. The process of claim 14, further comprising:
extending the sheath material from the tip toward the root portion a predetermined length along the airfoil portion proximate the trailing edge.

20. The process of claim 14, further comprising:
extending the sheath material across the airfoil portion chord-wise a predetermined distance.
